(19) United States
(12) Patent Application Publication
(10) Pub. No.: US 2004/0004974 A1
(43) Pub. Date: Jan. 8, 2004

(54) Method and system for optimizing the design of a network controller

(76) Inventor: Harand Gaspar, Cupertino, CA (US)

Correspondence Address: KELLY K KORDZIK, WINSTEAD SECHREST & MINICK P.C., 1201 MAIN STREET, P.O. BOX 50784, DALLAS, TX, 75250-0784, US

(21) Appl. No.: 10/190,088

(22) Filed: Jul. 2, 2002

(51) Int. Cl. H04L 12/66

(52) U.S. Cl. 370/463

(57) ABSTRACT

A method and system for optimizing the design of a network controller in a home phone line network is described. More particularly, embodiments of the present invention provide a system for networking computers in a home phone line network. The system includes a first controller that includes a physical layer (PHY) configured to be coupled to a phone line, and a media access control (MAC) configured to be coupled to the PHY. The MAC is separated from the PHY by a partition. The partition enables the MAC to be implemented as a separate circuit from the PHY such that the MAC can be modified during and after the design process while leaving the PHY intact.

### FIELD OF THE INVENTION

The present invention relates to computer networks, and more particularly to a method and system for optimizing the design of a network controller in a home phone line network.

### BACKGROUND OF THE INVENTION

Home networks are becoming more common and desirable for connecting computers within a home. One type of home network is the home phone line network, which uses existing telephone lines in residential homes for communication among computers. The Home Phone Line Networking Alliance (HPNA) has published a specification to standardize the behavior of home phone line networks. In such home phone line networks, phone lines can be used to send digital packets among computers.

In such a network, a HPNA controller receives signals containing data packets through telephone wires via a phone jack. The HPNA controller then processes the data packets. The HPNA controller includes a physical layer (PHY) and a media access control (MAC). The PHY transmits various types of data frames onto the phone line, such as normal data frames.

Although the present invention disclosed herein is described in the context of networks complying with HPNA standards, the present invention can apply to other standards as well.

One problem with the design of an HPNA controller is that as protocols change or standards evolve, the HPNA controller must be upgraded. For example, a home phone line network needs to comply with the current version of the HPNA specification. If an upgrade is required during the design process, the HPNA controller must redesigned. Accordingly, upgrading can be costly and time consuming.

Accordingly, what is needed is a method and system for optimizing the design of a network controller. The method and system should enable convenient modifications of the architecture of the network controller. The present invention addresses such a need.

### SUMMARY OF THE INVENTION

The present invention achieves the above needs and others with a method and system for optimizing the design of a network controller. More particularly, embodiments of the present invention provide a system for networking computers in a home phone line network. The system includes a first controller that includes a physical layer (PHY) configured to be coupled to a phone line, and a media access control (MAC) configured to be coupled to the PHY. The MAC is separated from the PHY by a partition. The partition enables the MAC to be implemented as a separate circuit from the PHY such that the MAC can be modified during and after the design process while leaving the PHY intact.

According to the method and system disclosed herein, the embodiments of present invention enables convenient modifications of the architecture of a network controller. Consequently, the design process is optimized.

### BRIEF DESCRIPTION OF THE DRAWINGS

FIG. 1 is a block diagram of a home phone line network station in accordance with the present invention;

FIG. 2 is a block diagram of a MAC and a PHY in accordance with the present invention;

FIG. 3 is a table of I/O pin descriptions of an ISIS PHY interface in accordance with the present invention; and

FIG. 4 is a block diagram of a MAC for a HPNA controller in accordance with the present invention.

### DETAILED DESCRIPTION

The present invention relates to computer networks, and more particularly to a method and system for optimizing the design of a network controller in a home phone line network. The following description is presented to enable one of ordinary skill in the art to make and use the invention and is provided in the context of a patent application and its requirements. Various modifications to the preferred embodiment and the generic principles and features described herein will be readily apparent to those skilled in the art. Thus, the present invention is not intended to be limited to the embodiment shown but is to be accorded the widest scope consistent with the principles and features described herein.

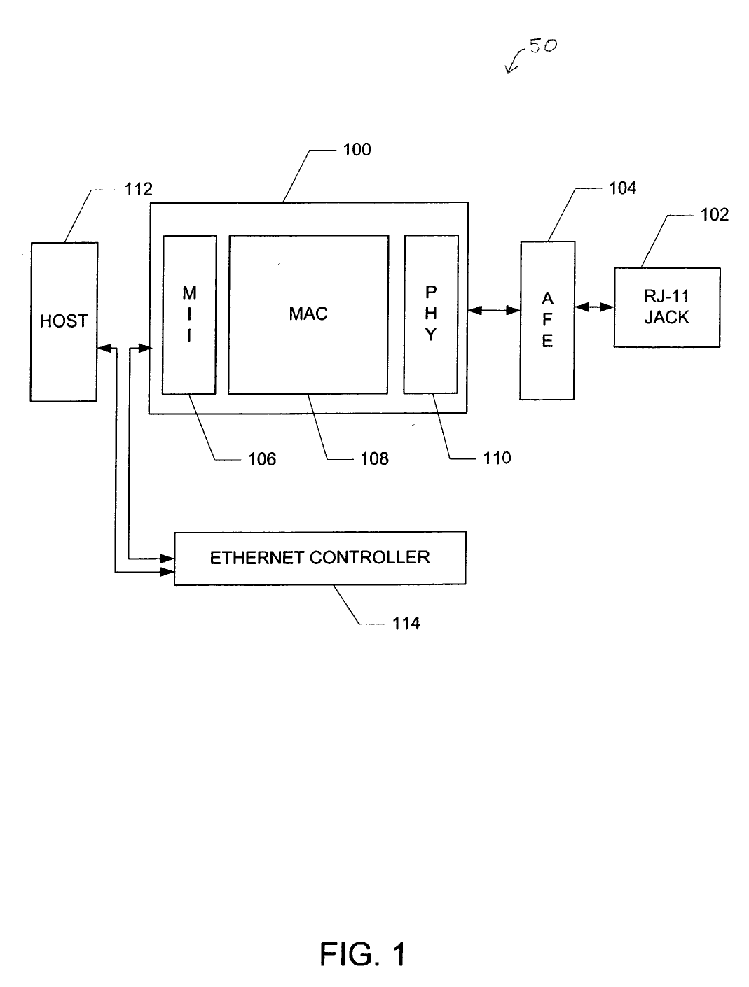

Generally, embodiments of the present invention enable convenient modifications to a controller circuit during and after the design process by partitioning a MAC circuit from a PHY circuit. By partitioning the MAC and PHY circuits, the MAC circuit can be implemented with a programmable device such as an FPGA. As such, the controller circuit can be debugged or upgraded by modifying the MAC circuit, leaving the PHY circuit intact. This results in cost and time savings. FIG. 1 describes an embodiment of the present invention.

FIG. 1 is a block diagram of a home phone line network station 50 in accordance with the present invention. The network allows multiple computers to communicate through existing telephone wires, which have been installed in residential homes. The network station 50 includes a network controller 100. In a preferred embodiment, the network controller is a Home Phone Line Networking Alliance (HPNA) controller 100. Note that the present invention is not limited to network or HPNA controllers and may apply to other controllers and still remain within the spirit and scope of the present invention.

The network controller 100 includes a media independent interface (MII) 106, a media access control (MAC) 108, and a Physical Layer (PHY) 110. The network station also includes a phone jack 102, an analog front end (AFE) 104, a host 112, and an Ethernet controller 114. In this specific embodiment, the Ethernet controller 114 is an Ethernet MAC controller. In another specific embodiment, the Ethernet controller 114 uses a media independent interface (MII).

In accordance with the present invention, there is a partition between the MAC and the PHY. Information flows back and forth between the MAC and the PHY across the partition. The partition enables the MAC to be implemented as a separate circuit from the PHY, which enables the MAC to be modified during and after the design process while leaving the PHY intact.

In operation, the network controller 100 receives signals containing data packets through a telephone wire (not shown) via the phone jack 102. The AFE 104 processes the signals between the network controller 100 and the telephone wire. The network controller 100 processes the data packets received in the signals from the AFE 104 and outputs signals to the Ethernet controller 114. In this specific embodiment, the network station 50 complies with the current version (e.g., HPNA 2.0). Accordingly, the network controller 100 implements the current HPNA specification. The network controller may also implement other specification standards depending on the specific application.

The Ethernet controller 114 can send normal data frames from HPNA software at the host 112 to the phone line via the MAC 108 and the PHY 110. The PHY 110 comprises a transmit FIFO (not shown) for transmitting frames onto the phone line. According to one version of the HPNA specification, prior to each normal data frame, a frame control frame (FCF) is sent via the Ethernet controller 114 to the network controller 100. The FCF comprises information needed by the MAC 108, such as the current data rate used by the network station. The FCF is not transmitted to the PHY 110 or the phone line.

In addition to transmission of the normal data frame from the Ethernet controller 114, the HPNA MAC 108 also sends two other types of frames to the phone line through the PHY 110: a link-integrity control frame (LICF) and a rate-request control frame (RRCF). The LICF includes information concerning the physical conditions of the network. The RRCF includes information required for performing the rate negotiation function, i.e., to determine the data rate required to communicate between different stations in a home phone line network.

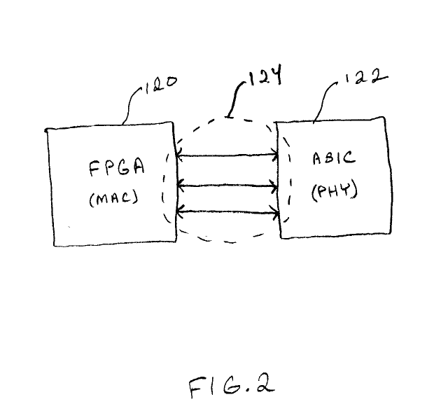

FIG. 2 is a block diagram of a MAC 120 and a PHY 122 in accordance with the present invention. The MAC 120 and the PHY 122 can be used to implement the network controller 100 of FIG. 1. Still referring to FIG. 2, an interface 124 is also shown. In this specific embodiment, the interface is an ISIS PHY interface. The MAC 120 is implemented with a field programmable gate array (FPGA). Note that the MAC 120 is not limited to being implemented with FPGAs and can also be implemented with other programmable devices such as a programmable logic device. The programmability of the MAC 120 is beneficial because during the development of a controller because the MAC may need to be modified to comply with current protocols or standards. Also, the MAC can be easily debugged during the development of the controller.

The MAC 120 is partitioned from the PHY 122. The partition enables the MAC 120 to be implemented as a separate circuit from the PHY 122, which enables the MAC 120 to be modified during and after the design process while leaving the PHY 122 intact. For example, the MAC 120 can be implemented with an FPGA or other type of programmable device such as a programmable logic device, and the PHY 122 can be implemented with an application-specific integrated circuit (ASIC). As such, if a modification of the MAC 120 is required, only the MAC 120 needs to be modified. The PHY 122 can remain intact.

The PHY 122 is typically designed with an ASIC because its functions are complex. For example, the PHY 122 can have an analog-to-digital (A/D) converter function, a signal processing function such as a digital signal processor (DSP) function, or other function. The functions performed by the PHY 122 are typically standard functions. Accordingly, the design of the PHY portion of the controller need not be modified with every protocol change or change in the standard.

Thus, as protocols change and standards evolve, only the MAC portion of the controller needs to be upgraded. This saves considerable costs and time during the development of the controller.

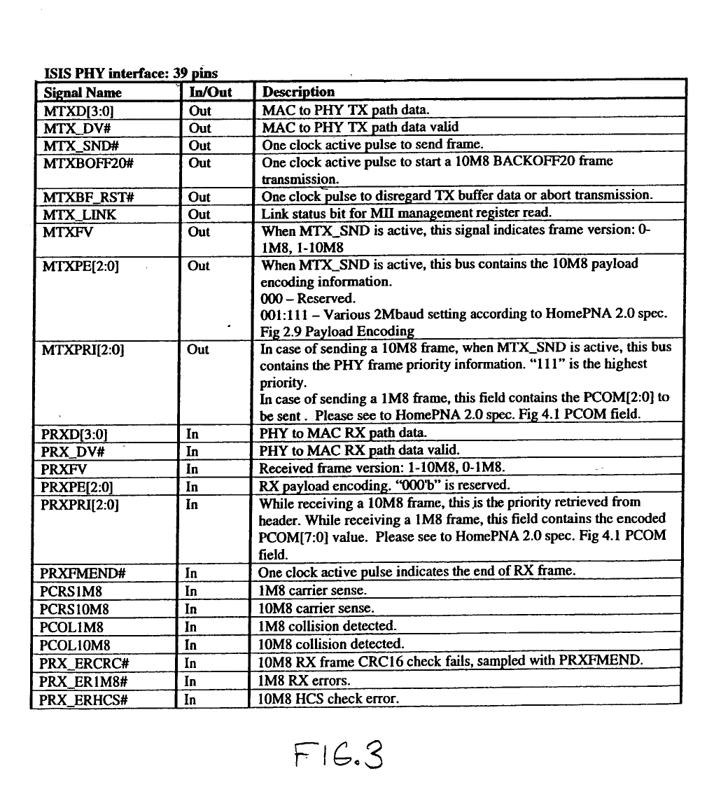

FIG. 3 is a table of I/O pin descriptions of an ISIS PHY interface in accordance with the present invention. The I/O pin descriptions can be used to implement the interface 124 of FIG. 2. Still referring to FIG. 3, the PRXD[3:0] signal includes the PHY to MAC RX path data. The PRX_DV# signal includes information regarding the validity of the PHY to MAC RX path data.

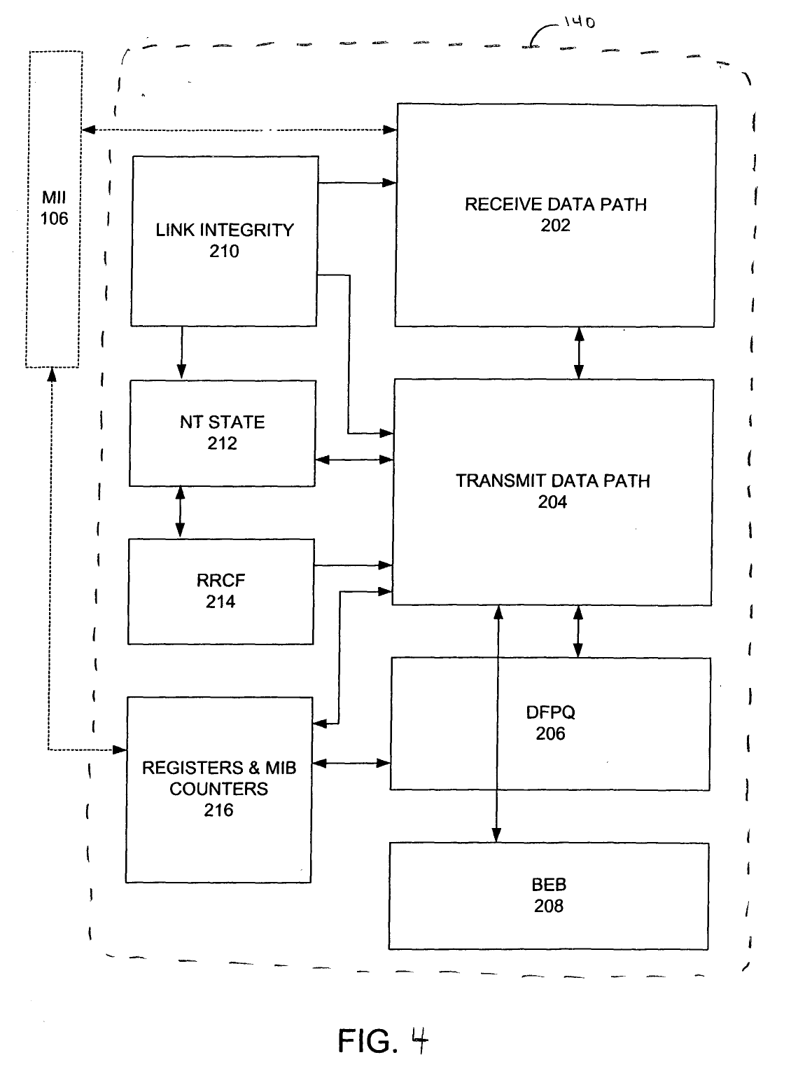

FIG. 4 is a block diagram of a MAC 140 for a controller in accordance with the present invention. The MAC 140 can be used to implement the MAC 108 of FIG. 1 or the MAC 122 of FIG. 2. Still referring to FIG. 4, the MAC 140 includes a receive data path 202, a transmit data path 204, a distributed fair priority queuing circuit (DFPQ) 206, a binary exponential back-off circuit (BEB) 208, a link integrity circuit 210, a network state circuit 212, a rate request control frame (RRCF) 214, and a plurality of registers and management information base (MIB) counters 216.

The receive data path 202 receives data packets from a PHY (not shown) and sends data packets to the MII 106 (first introduced in FIG. 1). In a preferred embodiment, after each data packet sent by the receive data path 202, another packet, referred to herein as a “frame status frame,” is sent immediately following. The frame status frame contains certain status information required by subsequent processes.

According to the method and system disclosed herein, the present invention provides numerous benefits. For example, it enables convenient modifications of the architecture of a network controller.

Embodiments of the present invention enable certain portions of the architecture to be modified while leaving other portions of the circuit intact.

Although the present invention has been described in accordance with the embodiments shown, one of ordinary skill in the art will readily recognize that there could be variations to the embodiments and those variations would be within the spirit and scope of the present invention. Accordingly, many modifications may be made by one of ordinary skill in the art without departing from the spirit and scope of the appended claims.

What is claimed is:

1. A system for networking computers in a home phone line network, the system comprising:
a first controller that includes:
a physical layer (PHY) configured to be coupled to a phone line; and
a media access control (MAC) configured to be coupled to the PHY, wherein the MAC is separated from the PHY by a partition, wherein the partition enables the MAC to be implemented as a separate circuit from the PHY such that the MAC can be modified during and after a design process while leaving the PHY intact; and
a second controller configured to be coupled to the first controller.

2. The system of claim 1 wherein the PHY is an application-specific integrated circuit.

3. The system of claim 1 wherein the PHY is a signal processor.

4. The system of claim 1 wherein the PHY is a digital signal processor.

5. The system of claim 1 wherein the MAC is a programmable device.

6. The system of claim 1 wherein the MAC is a programmable logic device.

7. The system of claim 1 wherein the MAC is a field programmable gate array.

8. The system of claim 1 wherein the first controller is a Home Phone Line Networking Alliance controller.

9. The system of claim 1 wherein the second controller is an Ethernet controller.

10. A controller comprising:
a physical layer (PHY) configured to be coupled to a phone line; and
a media access control (MAC) configured to be coupled to the PHY, wherein the MAC is separated from the PHY by a partition, wherein the partition enables the MAC to be implemented as a separate circuit from the PHY such that the MAC can be modified during and after a design process while leaving the PHY intact.

11. The system of claim 10 wherein the PHY is an application-specific integrated circuit.

12. The system of claim 10 wherein the PHY is a signal processor.

13. The system of claim 10 wherein the PHY is a digital signal processor.

14. The system of claim 10 wherein the MAC is a programmable device.

15. The system of claim 10 wherein the MAC is a programmable logic device.

16. The system of claim 10 wherein the MAC is a field programmable gate array.

17. The system of claim 10 wherein the controller is a Home Phone Line Networking Alliance controller.

18. A circuit comprising:
a physical layer (PHY) configured to be coupled to a phone line, wherein the PHY is an application-specific integrated circuit; and
a media access control (MAC) configured to be coupled to the PHY, wherein the MAC is a programmable device, wherein the MAC can be modified during and after a design process while leaving the PHY intact.

19. The system of claim 18 wherein the PHY is a signal processor.

20. The system of claim 18 wherein the PHY is a digital signal processor.

21. The system of claim 18 wherein the MAC is a programmable logic device.

22. The system of claim 18 wherein the MAC is a field programmable gate array.

23. The system of claim 18 wherein the controller is a Home Phone Line Networking Alliance controller.

24. A system for networking computers in a home phone line network, the system comprising:
an Home Phone Line Networking Alliance controller (HPNA) controller that includes:
a physical layer (PHY) configured to be coupled to a phone line, wherein the PHY is an application-specific integrated circuit; and
a media access control (MAC) configured to be coupled to the PHY, wherein the MAC is separated from the PHY by a partition, wherein the MAC is a programmable device, wherein the partition enables the MAC to be implemented as a separate circuit from the PHY such that the MAC can be modified during and after a design process while leaving the PHY intact; and
an Ethernet controller configured to be coupled to the first controller.

25. A method for optimizing a design of a network controller, the network controller including a physical layer (PHY) and a media access control (MAC), the PHY being configured to be coupled to a phone line, the MAC being configured to be coupled to the PHY, the method comprising the step of:
(a) separating the MAC from the PHY by a partition, wherein the partition enables the MAC to be implemented as a separate circuit from the PHY such that the MAC can be modified during and after a design process while leaving the PHY intact.

26. The method of claim 25 wherein the PHY is an application-specific integrated circuit.

27. The method of claim 25 wherein the PHY is a signal processor.

28. The method of claim 25 wherein the PHY is a digital signal processor.

29. The method of claim 25 wherein the MAC is a programmable device.

30. The method of claim 25 wherein the MAC is a programmable logic device.

31. The method of claim 25 wherein the MAC is a field programmable gate array.

32. The method of claim 25 wherein the controller is a Home Phone Line Networking Alliance controller.
